(19) United States
(12) Patent Application Publication
(10) Pub. No.: US 2004/0244544 A1
(43) Pub. Date: Dec. 9, 2004

(54) Ratchet tool having operation levers on two sides of the tool

(76) Inventor: Chih-Ching Hsien, Taipei (TW)

Correspondence Address: Chih-Ching Hsien, 235 Chung - Ho, Box 8-24, Taipei, TW

(21) Appl. No.: 10/890,833

(22) Filed: Jul. 14, 2004

Related U.S. Application Data
(63) Continuation-in-part of application No. 10/289,277, filed on Nov. 7, 2002, now abandoned.

(51) Int. Cl. B25B 13/46

(52) U.S. Cl. 81/63.2

(57) ABSTRACT

A ratchet tool includes a head having a hole defined therethrough for an engaging member engaged therewith and a recess is defined in an inner periphery of the hole so as to receive a pawl therein. The pawl has a toothed surface which is engaged with a toothed outer periphery of the engaging member. Two operation levers are respectively connected to two opposite sides of the tool and a torsion spring is biased between respective one of the two operation levers and a side of the pawl.

The present invention is a continuation in part (CIP) of the U.S. patent Ser. No. 10/289,277, invented and assigned to the inventor of the present invention. Thus the content of the U.S. patent with Ser. No. 10/289,277 is incorporated into the present invention as a part of the present invention.

### FIELD OF THE INVENTION

The present invention relates to a ratchet tool that has two operation levers on two sides of the tool so that the user can reach the operation lever from whichever side of the tool.

### BACKGROUND OF THE INVENTION

A conventional ratchet tool generally includes a head with a ratchet mechanism received therein and an engaged member is rotatably engaged with a hole defined through the head of the tool. The ratchet mechanism includes a pawl which has toothed surface for being matched with the engaging member and can be controlled by an operation lever on a side of the tool. The user may operate the operation lever to change the effective direction for outputting a torque. Nevertheless, in some situations, the space for the tool to be inserted is limited and the operation lever at only one side of the ratchet tool could not be convenient for the user to approach.

The present invention intends to provide a ratchet tool that has two operation levers on two sides of the tool such that the user can easily and convenient to operate the operation lever from whichever side of the tool.

### SUMMARY OF THE INVENTION

In accordance with one aspect of the present invention, there is provided a ratchet tool that has an engaging member controlled by a pawl received in a recess in an inner periphery of the hole in the head. Two operation levers are connected to two sides of the pawl respectively and the two operation levers are accessed from two opposite sides of the tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet tool of the present invention;

FIG. 2 is an exploded view to show the ratchet tool of the present invention;

FIG. 3 shows the arrangement of the parts of the ratchet tool of the present invention;

FIGS. 4 to 6 show various types of the positions and the shapes of the operation levers of the ratchet tool of the present invention.

### DETAILED DESCRIPTION OF THE PREFERRED EMBODIMENT

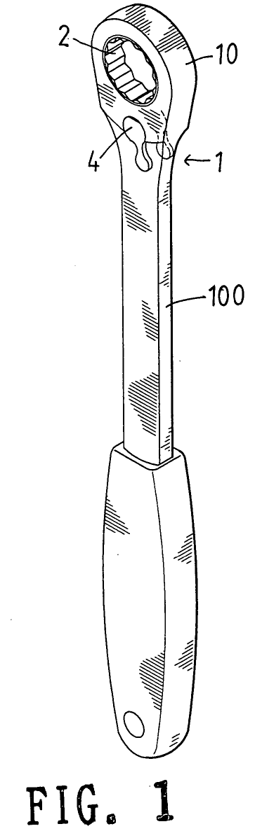

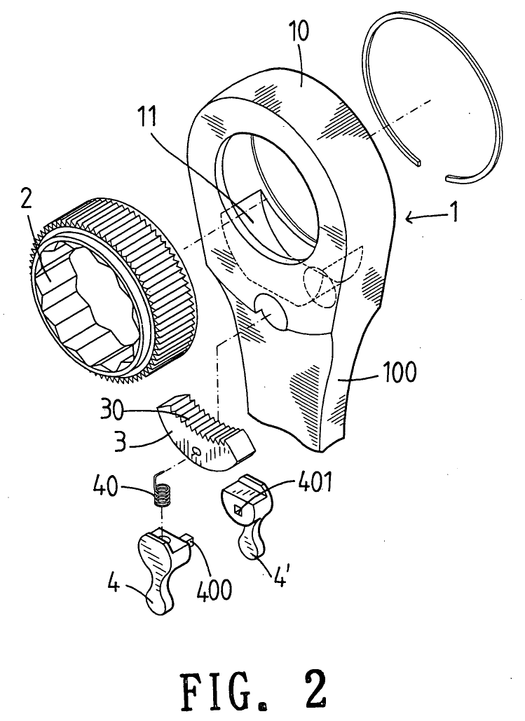

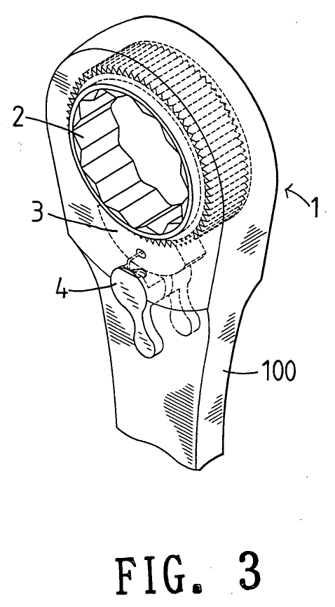

Referring to FIGS. 1 to 3, the ratchet tool 1 of the present invention comprises a head 10 having a hole defined therethrough and a recess 11 is defined in an inner periphery of the hole. A pawl 3 is slidably received in the recess 11 and has a toothed surface 30. An engaging member 2 having a toothed outer periphery is rotatably received in the hole of the head 10 and the toothed outer periphery is engaged with the toothed surface 30 of the pawl 3.

An operation member includes two operation levers 4, 4′. One of the operation levers 4 has an insertion 400 and the other operation lever 4′ has a recess 401 for receiving the insertion 400. The operation member is received in a passage in the head 10 and the two operation levers 4, 4′ are respectively connected to two opposite sides of the tool and a torsion spring 40 is biased between the operation lever 4 and a side of the pawl 3. The insertion 400 of one of the two operation levels 4 is a rectangular projection and the recess 401 for receiving the insertion 400 in the other of the operation level 4′ is a rectangular recess. The two operation levers 4, 4′ can be accessed from either side of the tool and the two operation levers 4, 4′ are shifted when either one of them is shifted.

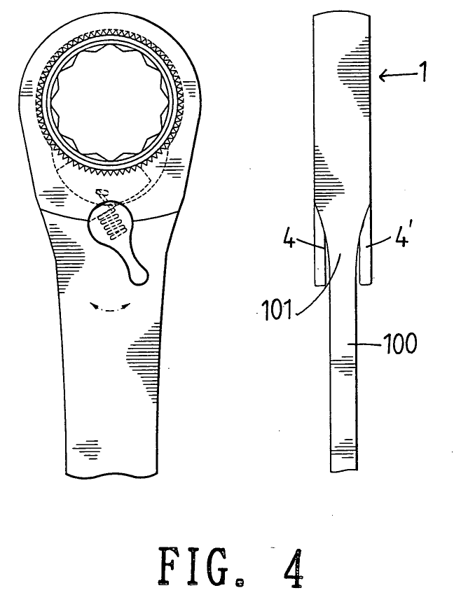

Referring to FIG. 4, a neck portion 101 is located at a conjunction portion of the head 10 and a handle 100, and the two operation levers 4, 4′ are located at two opposite sides of the neck portion 101 such that the two operation levers 4, 4′ do not protrude from the sides of the tool.

In FIGS. 1 to 4, it is illustrated that each operation member has a dumbbell shape.

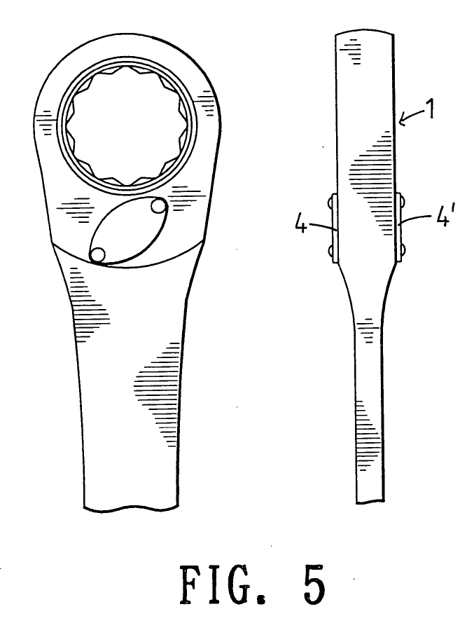

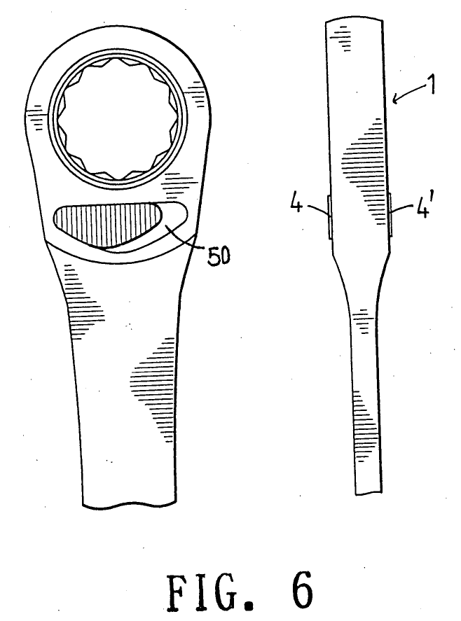

FIGS. 5 and 6 show various types of the positions and the shapes of the operation levers 4, 4′ of the ratchet tool of the present invention. The ratchet tool of the present invention allows the user to access the operation lever 4 or 4′ form whichever side of the tool. In FIG. 5, it is illustrated that each operation lever has an elliptical shape with two nose portions at two ends along a long axis of the elliptical shape. In FIG. 6, it is illustrated that each side of the outer side of the head 10 has a groove 50. Each groove 50 is located with a respective operation lever 4, 4′. The area of each operation lever 4, 4′ is smaller than that of the respective groove 50 so that the operation lever 4, 4′ is movable in the groove 50 and thus the torsion spring 40 is driven so as to drive the pawl 3.

While we have shown and described the embodiment in accordance with the present invention, it should be clear to those skilled in the art that further embodiments may be made without departing from the scope of the present invention.

What is claimed is:

1. A ratchet tool comprising:
a head having a hole defined therethrough and a neck portion located at a conjunction portion of the head and a handle connected to the head, an engaging member rotatably received in the hole of the head and having a toothed outer periphery;
a pawl having a toothed surface and slidably located adjacent the engaging member, the toothed outer periphery of the engaging member engaged with the toothed surface of the pawl, and
an operation member including two operation levels connected to the head and two operation levels respectively connected two opposite sides of the neck portion of the tool, a torsion spring biased between the operation member and a side of the pawl, one of the two operation levers having an insertion and the other operation lever having a recess for receiving the insertion.

2. The ratchet tool as claimed in claim 1, wherein the insertion of one of the two operation levers is a rectangular projection and the recess for receiving the insertion in the other of the operation lever is a rectangular recess such that when either one of the operation levers is shifted, the operation member is shifted.

3. The ratchet tool as claimed in claim 2, wherein each operation lever has a dumbbell shape.

4. The ratchet tool as claimed in claim 2, wherein each operation lever has an elliptical shape with two nose portions at two ends along a long axis of the elliptical shape.

5. The ratchet tool as claimed in claim 2, wherein each side of the outer side of the head has a groove; each groove is located with a respective operation lever; the area of the operation member is smaller than that of the groove so that the operation lever is movable in the groove and thus the torsion spring is driven so as to drive the pawl.

6. The ratchet tool as claimed in claim 1, wherein each operation lever has a dumbbell shape.

7. The ratchet tool as claimed in claim 1, wherein each operation lever has an elliptical shape with two nose portions at two ends along a long axis of the elliptical shape.

8. The ratchet tool as claimed in claim 1, wherein each side of the outer side of the head has a groove; each groove is located with a respective operation lever; the area of the operation lever is smaller than that of the groove so that the operation lever is movable in the groove and thus the torsion spring is driven so as to drive the pawl.
